(19) United States
(12) Patent Application Publication
(10) Pub. No.: US 2007/0170008 A1
(43) Pub. Date: Jul. 26, 2007

(54) Elevator landing door system having fire protective device

(76) Inventor: Jae-Jung Na, Busan (KR)

Correspondence Address: Lisa A Bongiovi;Otis Elevator Company, 10 Farm Springs, Farmington, CT, 06032, US

(21) Appl. No.: 10/580,353

(22) PCT Filed: Dec. 3, 2004
(86) PCT No.: PCT/US04/40511

§ 371 Date: May 23, 2006

(30) Foreign Application Priority Data
Dec. 4, 2003 (KR) 10-2003-0087471

(51) Int. Cl. B66B 13/24

(52) U.S. Cl. 187/336

(57) ABSTRACT

The present invention pertains to an elevator landing door system having a fire prevention device that prevents flame or smoke from penetrating into a shaft (60) from a landing and being spread throughout the entire building by blocking the gap between door panels (11, 11′) when a fire breaks out in a building. The elevator landing door system having a fire prevention device consists of door panels (11, 11′) that are opened and closed; a fire prevention plate (40) that extends alongside the opening and closing edge surface (11b) of one door panel (11) on the side (11b) facing the elevator, equipped with a downward slot (42) inclined toward the opening and closing edge of the door panel, and fixed to the door panel by a fastening means (46) penetrating through the slot; and fixtures (44) made of a fusible material that are tightly attached together with the door panel and the fire prevention plate by the fastening means. The fixtures (44) are arranged between the door panel (11) and the fire prevention plate (40) or between the fire prevention plate (40) and the fastening means (46) and are made of plastic or lead.

### TECHNICAL FIELD OF THE INVENTION

The present invention pertains to an elevator landing door. More specifically, the present invention pertains to an elevator landing door having a device that prevents the flame or smoke from penetrating into a shaft through the gap between landing door panels.

In general, a landing door is an entrance to an elevator car that is installed at an elevator landing on each floor in a building. The landing door is usually closed, and blocks the opening between the landing side and the shaft side where the elevator car ascends and descends, and is opened and closed by interlocking with a car door when the elevator car arrives.

FIGS. 1 and 2 are a rear view and a vertical section showing a conventional elevator landing door, and FIG. 3 is a horizontal section showing a state in which the conventional elevator landing door has been deformed by heat. In FIG. 2, the left side of landing door 10 is a landing 50, and the right side is a shaft 60.

A pocket 12 is formed in an upper wall 20 of the landing entrance, and a rail 14 is installed in the pocket 12.

A hanger 16 is installed at the top of a pair of door panels 11, 11′ that are symmetrically arranged on the left and right, and a hanger roller 18 that is guided by the rail 14 is mounted on the hanger 16. While the hanger roller 18, rolls along the rail 14, the door panels 11, 11′ slide to the left and right sides and open and close.

A sill 32 is installed in floor 30 of the landing and a guide shoe 19 sliding along a guide groove 34 provided in the sill 32 is mounted at the bottom of the door panels 11, 11′.

However, if the conventional elevator landing door is heated by a fire in a building, the door panels 11, 11′ may begin to deform, and eventually a gap may open between the door panels 11, 11′ as shown in FIG. 3. Flame or smoke penetrates through the gap from the landing 50 into the shaft 60, and the shaft may then act as a chimney so that the flame or smoke spreads to other floors of the building, thereby further increasing damage from the fire.

### DISCLOSURE OF THE INVENTION

The present invention solves these problems of the prior art by providing an elevator landing door system having a fire prevention device that prevents flame or smoke from penetrating into a shaft from a landing and spreading throughout the entire building by blocking the gap between door panels when a fire is present on the landing.

In order to achieve the above-mentioned purpose, the elevator landing door system having a fire prevention device consists of door panels that are opened and closed; a fire prevention plate, which extends alongside the opening and closing edge surface of the door panel on the side facing the elevator, equipped with a downward slot inclined toward the opening and closing edge of the door panel, and fixed to the door panel by a fastening means penetrating through the slot; and fixtures made of a fusible material that are tightly attached together with the door panel and the fire prevention plate by the fastening means. The fixtures are arranged between the door panel and the fire prevention plate or between the fire prevention plate and the fastening means.

Preferably, the fixtures are made of plastic or lead.

### BRIEF DESCRIPTION OF THE FIGURES

FIG. 1 is a rear view showing a conventional elevator landing door.

FIG. 2 is a vertical section showing a conventional elevator landing door.

FIG. 3 is a horizontal section showing a state in which a conventional elevator landing door is deformed by heat.

FIG. 4a is a rear view showing an elevator landing door with a fire prevention device of the present invention.

FIG. 4b is a cross section showing the fire prevention device of the first application example of the present invention.

FIG. 5a is a rear view showing the operating state of the fire prevention device of the first application example of the present invention.

FIG. 5b is a cross section showing the operating state of the fire prevention device of the first application example of the present invention.

FIG. 6 is a cross section showing the elevator landing door with a fire prevention device of the second application example of the present invention.

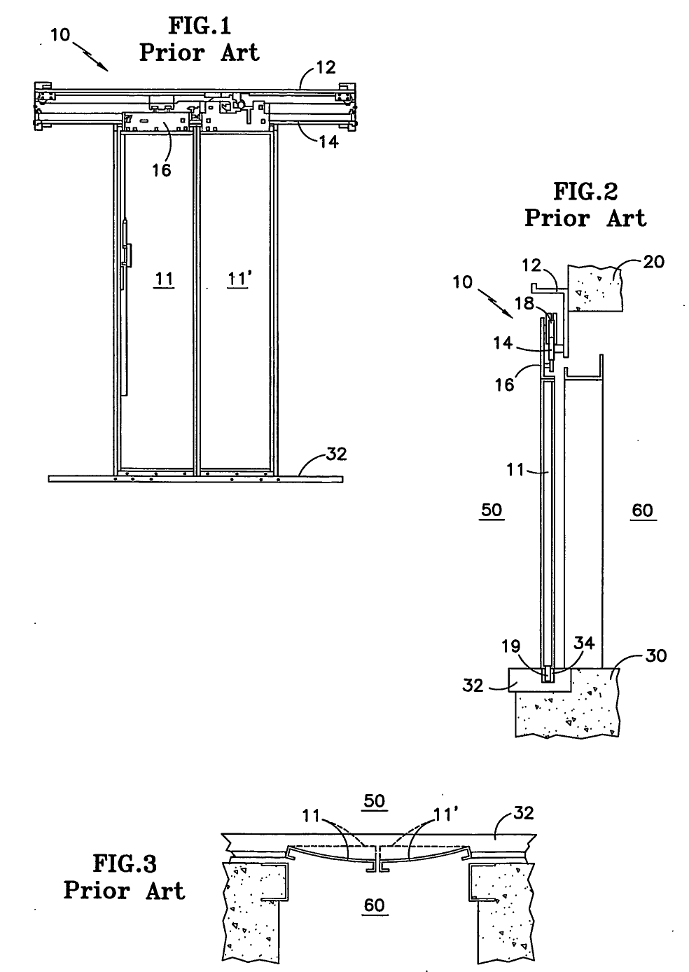

### BEST MODE

Next, a preferred application example of the present invention will be explained in detail with reference to the attached figures.

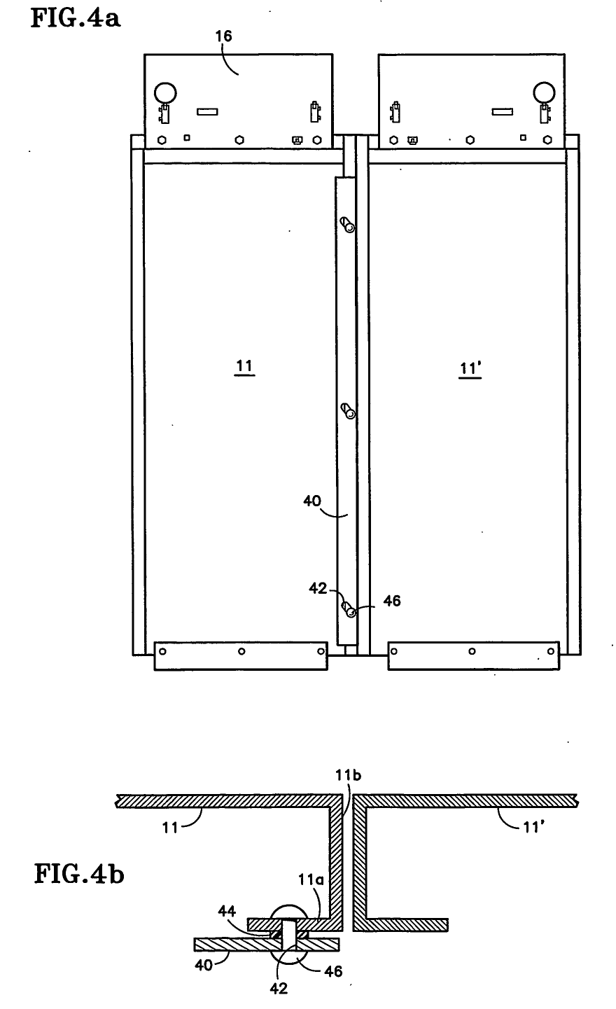

FIGS. 4a and 4b are a rear view and a cross section showing the elevator landing door system having a fire prevention device of the first application example of the present invention.

As shown in the figures, an oblong fire prevention plate 40 is positioned on a back surface part 11a, facing the shaft, of one door panel 11 of the two door panels 11, 11′ of an elevator landing door, and fixtures 44 are arranged between the back face 11a of the door panel 11 and the fire prevention plate 40. The door panel 11, fixture 44, and fire prevention plate 40 are fixed to each other by fastening means such as rivets 46 with a prescribed holding strength.

The fire prevention plate 40 extends for about the same length as the height of the door panel 11, along the opening and closing edge 11b of the door panel 11 facing the adjacent door panel 11′.

Also, the fire prevention plate 40 is equipped with one or more slots 42 so that rivets 46 can pass through them, and the slot 42 is inclined downward at a prescribed angle toward the opening and closing edge 11b of the door panel 11 and has a prescribed length.

In a normal case, the rivet 46 passes through the lowermost part of the inclined slot 42 of the fire prevention plate 40, and the fixture 44. The fire prevention plate 40, fixture 44 and the door panel 11 are fastened together, so that the latter cannot project beyond the opening and closing edge 11b of the door panel 11, and so that the entrance and exit of passengers is not impeded.

The above-mentioned fixtures 44 are made of a fusible material, such as plastic or lead, that is easily melted by applying heat.

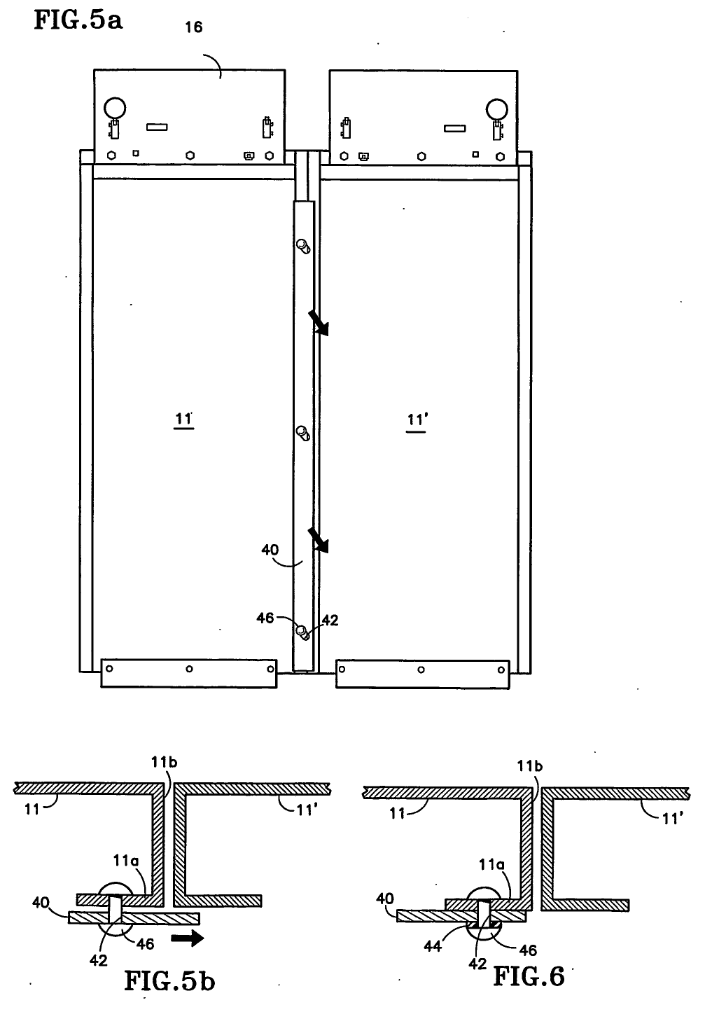

FIGS. 5a and 5b are a rear view and a cross section showing an operating state of the fire prevention device of the first application example of the present invention. The operation and effects of the fire prevention device of the first application example of the present invention will be explained with reference to these figures.

If a fire breaks out in a building and heat begins to be applied to the door panels 11, 11′, the heat is transferred to the fusible fixtures 44 and the fixtures 44 immediately melt away, so that the holding strength between the back surface 11a of the door panel 11 and the fire prevention plate 40 disappears. As a result, the fire prevention plate 40 moves by its weight along the downwardly inclined slot 42 a prescribed distance toward the opening and closing edge 11b of the door panel 11 such that it hangs from the door panel 11 by the rivets 46, so that any gap between two door panels 11, 11′ can be blocked. Flame or smoke can therefore be prevented from being introduced into the shaft through the gap between the door panels 11, 11′ from the landing and spreading throughout the entire building.

FIG. 6 is a cross section showing the elevator landing door having a fire prevention device of the second application example of the present invention. The fixture 44 is not positioned between the back surface 11a of the door panel 11 and the flame prevention plate 40, but is positioned between the fire prevention plate 40 and the head part of the rivet 46, and the same functional effects can be obtained as those in the above-mentioned first application example.

The present invention is not limited to the above-mentioned application examples but can be variously modified by anyone with ordinary skill in the field of the present invention without departing from the essence of the present invention described in the scope of the patent claims.

As explained in detail above, in the elevator landing door having a fire prevention device of the present invention, if a fire breaks out in a building and heat is transferred to the door panels, the fixtures made of a fusible material immediately melt away so that the fire prevention plate blocks the gap between a pair of door panels, and flame or smoke on the landing side can be prevented from being introduced into the shaft and spreading throughout the entire building.

Also, since the flame prevention device of the present invention can be operated simply by the high temperatures necessarily generated when a fire breaks out and the by weight of the fire prevention plate, without requiring a separate driving means for operating the fire prevention device, its installation structure is simple, and the installation cost is also low.

I claim:

1. An elevator landing door system having a fire prevention device comprising:
two door panels that are opened and closed;
a fire prevention plate extends alongside an opening and closing edge surface of one door panel on the side facing the elevator, said plate including a downward slot inclined toward the opening and closing edge of the door panel, and fixed to the door panel by a fastening means penetrating through the slot; and
fixtures made of a fusible material, said fixtures tightly attached together with the door panel and the fire prevention plate by the fastening means.

2. The elevator landing door having a fire prevention device of claim 1, wherein said fixtures are disposed between the one door panel and the said plate.

3. The elevator landing door having a fire prevention device of claim 1, wherein said fixtures are disposed between said plate and the fastening means.

4. The elevator landing door having a fire prevention device of claim 1, wherein said fixtures are made of plastic.

5. The elevator landing door having a fire prevention device of claim 1, wherein said fixtures are made of lead.
